(19) United States
(12) Patent Application Publication
(10) Pub. No.: US 2021/0059393 A1
(43) Pub. Date: Mar. 4, 2021

(54) Three-sided Brush Head for Electric Toothbrushes

(71) Applicant: Shenzhen Hanhui Network Technology Co., Ltd., Shenzhen (CN)

(72) Inventors: Wencheng Yang, Yueyang (CN); Jue Hou, Shenzhen (CN)

(73) Assignee: Shenzhen Hanhui Network Technology Co., Ltd.

(21) Appl. No.: 17/094,842

(22) Filed: Nov. 11, 2020

(30) Foreign Application Priority Data
Nov. 20, 2019 (CN) 201922015151.5

(51) Int. Cl. A46B 9/04; A46B 7/04; A46B 13/02; A61C 17/22; A46B 15/00

(52) U.S. Cl. CPC A46B 9/045; A46B 7/04; A46B 2200/1066; A61C 17/22; A46B 15/0081; A46B 13/023

(57) ABSTRACT

A three-sided brush head for electric toothbrushes comprises a C-shaped brush head body and a sleeve rod to be disposed around a power shaft of an electric toothbrush. A connecting groove is formed in a front side of the middle of the brush head body, and mounting grooves are formed in front sides of two ends of the brush head body. A back side of a top end of the sleeve rod is correspondingly mounted and integrally injection-molded in the in the connecting groove. Brush blocks are correspondingly injection-molded in the mounting grooves. Brush sets are disposed on the front side of the top end of the sleeve rod and on the brush blocks. An arc-shaped U-groove is formed in a back side of a corner of the brush head body.

### BACKGROUND OF THE INVENTION

### 1. Technical Field

The invention relates to the technical field of electric toothbrush heads, in particular to a three-sided brush head for electric toothbrushes.

### 2. Description of Related Art

As is commonly known, electric toothbrushes operate in such a manner that an electric motor rotates or vibrates quickly to make the brush head vibrate at a high frequency to alter toothpaste into foam which deeply penetrates into the spaces between teeth to realize a cleaning effect and that the bristles vibrate to promote blood circulation of the oral cavity and to fulfill a massage effect on gingival tissue.

At present, most brush heads of existing electric toothbrushes are single-sided brush heads and can only clean a single side of the teeth in operation. Some two-sided brush heads and even three-sided brush heads can realize multi-sided tooth cleaning, but such multi-sided brush heads have the structural defects of insufficient flexibility and thus are prone to damage, or the connection between different sizes is excessively rigid; the overall structure is large, and damage to gingivae may be caused.

### BRIEF SUMMARY OF THE INVENTION

To overcome the defects of the prior art, the objective of the invention is to provide a three-sided brush head for electric toothbrushes.

To fulfill the above objective, the invention adopts the following technical solution:

A three-sided brush head for electric toothbrushes comprises a C-shaped brush head body and a sleeve rod to be disposed around a power shaft of an electric toothbrush, wherein a connecting groove is formed in a front side of the middle of the brush head body, mounting grooves are formed in front sides of two ends of the brush head body, a back side of a top end of the sleeve rod is correspondingly mounted in the connecting groove and is integrally injection-molded in the connecting groove, brush blocks are injection-molded in the mounting grooves, brush sets are disposed on the front side of the top end of the sleeve rod and on the brush blocks, and an arc-shaped U-groove is formed in a back side of a corner of the brush head body.

Preferably, a plurality of sets of protrusions for removing tongue coatings are disposed on a back side of the brush head body.

Preferably, the three-sided brush head for electric toothbrushes further comprises a protective cover, wherein an insertion strip to be connected into the U-groove is disposed on an inner wall of the protective cover, a partition plate is vertically disposed in the protective cover, the insertion strip is correspondingly inserted into the U-groove, and the partition plate is inserted into a front side of the brush head body and clamps the brush head body together with the insertion strip.

Preferably, two end faces of the brush head body are arc.

By the adoption of the above solution, the utility model has the following advantages: three sides of teeth can be brushed through the brush sets on the brush blocks of the brush head body and the brush set on the sleeve rod; the brush head body is designed to be in a C shape and the U-groove is formed in the back side of the brush head body, so that the brush head body has better flexibility and crush resistance when both ends thereof are used for brushing teeth, the tooth brushing efficiency is improved, the teeth can be cleaned more comprehensively, and damage to the brush head body and injuries to the gum are avoided; the U-groove is in an arc shape, so that the brush head body can elastically deform more easily after both ends are stressed, and the flexibility is improved.

### BRIEF DESCRIPTION OF THE SEVERAL VIEWS OF THE DRAWINGS

FIG. 1 is a structural schematic diagram of an embodiment of the invention.

FIG. 2 is a perspective structural view of an embodiment of the invention.

FIG. 3 is a structural view of a back side of a brush head body in an embodiment of the invention.

FIG. 4 is a structural view of a protective cover in an embodiment of the invention.

FIG. 5 is an assembly view of the protective cover and the brush head body in an embodiment of the invention.

### DETAILED DESCRIPTION OF THE INVENTION

The embodiments of the invention are explained in detail below in combination with the accompanying drawings. The invention can be implemented in different ways defined and covered by the claims of the invention.

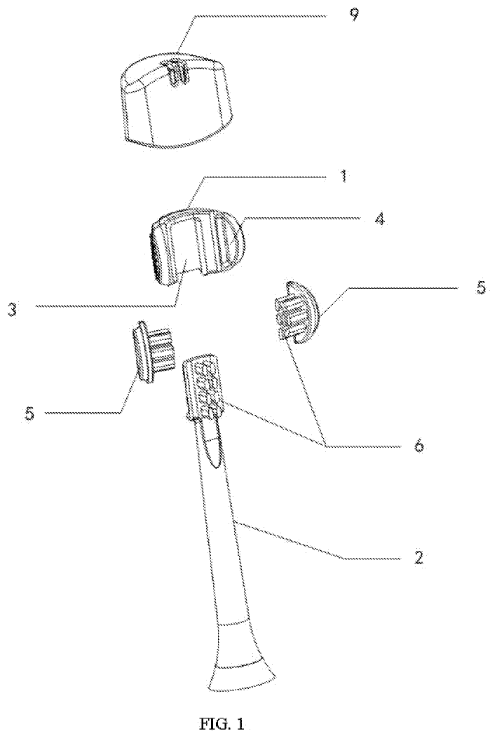

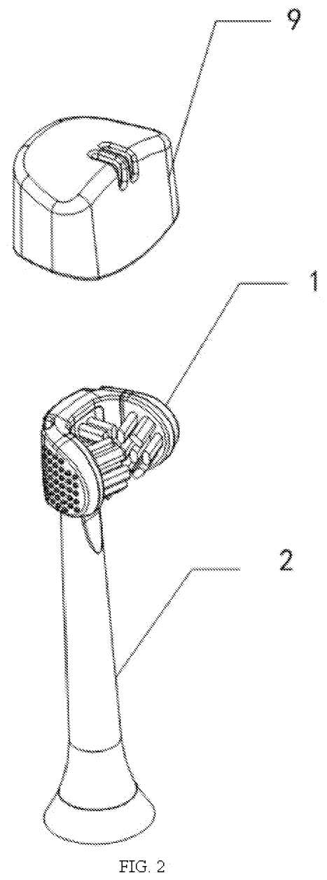

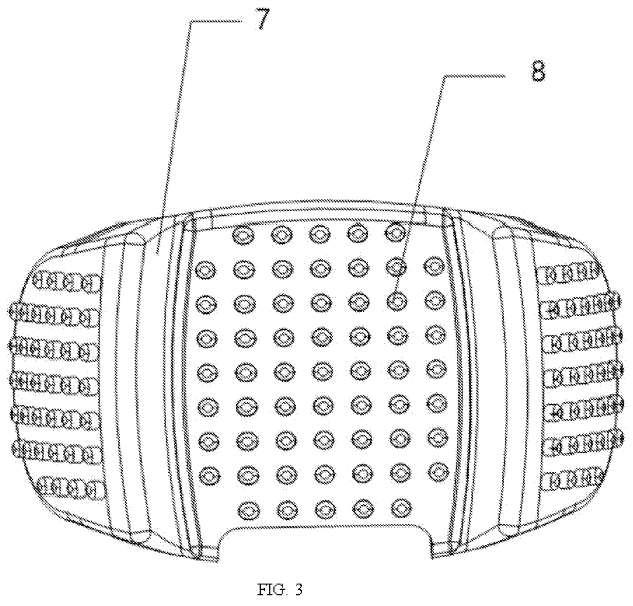

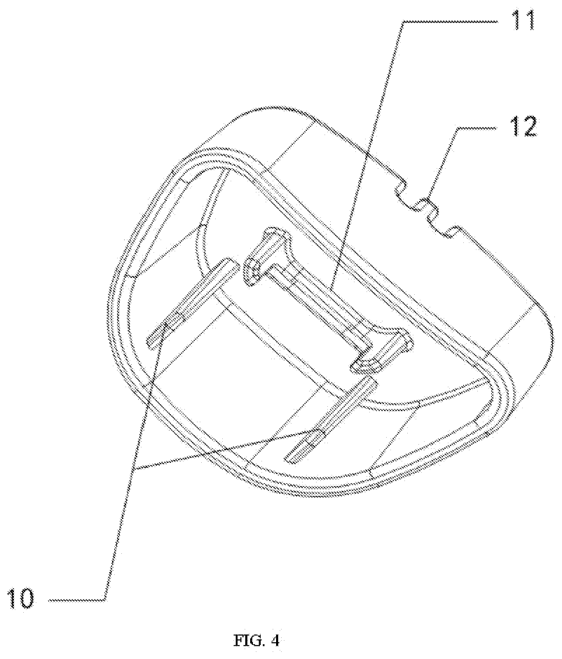

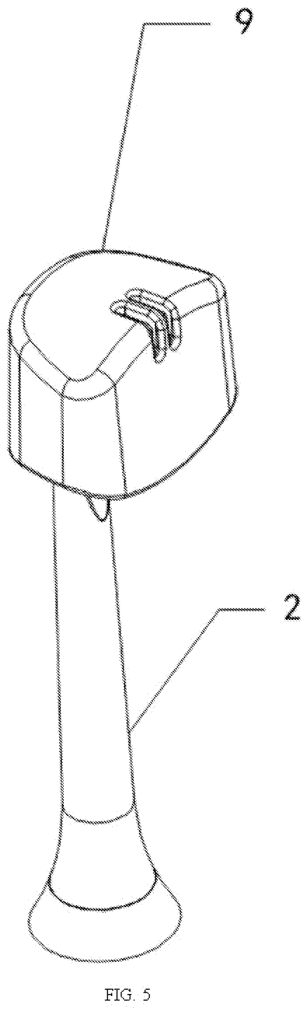

As shown in FIG. 1 to FIG. 5, this embodiment provides a three-sided brush head for electric toothbrushes. The three-sided brush head comprises a C-shaped brush head body 1 and a sleeve rod 2 to be disposed around a power shaft of an electric toothbrush, wherein a connecting groove 3 is formed in a front side of the middle of the brush head boy 1, mounting grooves 4 are formed in front sides of two ends of the brush head body 1, a back side of a top end of the sleeve rod 2 is correspondingly mounted and is integrally injection-molded in the connecting groove 3, brush blocks 5 are correspondingly mounted and injection-molded in the mounting grooves 4, brush sets 6 are disposed on the front side of the top end of the sleeve rod 2 and on the brush blocks 5, and an arc-shaped U-groove 7 is formed in a back side of a corner of the brush head body 1.

In this embodiment, the brush head body 1 is preferably made of soft rubber and has the following advantages:

First, the C-shaped brush head body 1 can brush three sides of teeth by means of the brush sets 6 on the brush blocks 5 and the brush set 6 on the sleeve rod 2 and can simultaneously clean three sides of the gum, so that the tooth brushing efficiency is improved;

Second, the brush head body 1 is designed to be in a C shape and the U-groove 7 is formed in the back side of the brush head body 1, so that the brush head body 1 has better flexibility and crush resistance when both ends thereof are used for brushing teeth, the tooth brushing effect is effectively optimized, the tooth brushing comfort and the protection effect are improved, and damage to the brush head body and injuries to the gum are avoided;

Third, in this embodiment, the U-groove 7 is in an arc shape, so that the brush head body can elastically deform more easily after both ends are stressed, and the problems of insufficient flexibility and stiffness between two sides are solved;

Fourth, the whole brush head body is assembled through a double-shot molding technique combining butt assembly and integrated formation, so that the brush head body can be produced industrially.

Furthermore, in this embodiment, to meet the requirement of users for removing tongue coatings, a plurality of sets of protrusions for removing the tongue coatings are disposed on a back side of the brush head body 1. The tongue coatings can be removed by the protrusions 8 on the back side of the brush head body 1.

Furthermore, the three-sided brush head in this embodiment further comprises a protective cover 9, wherein an insertion strip 10 to be connected into the U-groove 7 is disposed on an inner wall of the protective cover 9, a partition plate 11 is vertically arranged in the protective cover 9, the insertion strip 10 is correspondingly inserted into the U-groove 9, and the partition plate 11 is inserted into the front side of the brush head body 1 and clamps the brush head body 1 together with the insertion strip 10. When the brush head is not used, the protective cover 9 can be closed, and the brush head body 1 can be clamped by the insertion strip 10 and the partition plate 11 to be prevented from falling and can be covered by the protective cover 9 to be isolated from the outside; a ventilation hole 12 is formed in the protective cover 9 to realize ventilation and fulfill anti-bacterial effect, and the whole brush head is more attractive.

Furthermore, as for a non-optimized structure, two end faces of the brush head body 1 in this embodiment are arc, so that the end faces are smoother, the size is smaller, and injuries to the oral cavity are unlikely to be caused.

The above embodiments are merely preferred ones of the invention and are not intended to limit the patent scope of the invention. All equivalent structures or equivalent flow transformations obtained on the basis of the contents of the specification and drawings of the invention, or direct or indirect applications to other relating technical fields should also fall within the patent protection scope of the invention.

What is claimed is:

1. A three-sided brush head for electrical toothbrushes, comprising a C-shaped brush head body and a sleeve rod to be disposed around a power shaft of an electric toothbrush, wherein a connecting groove is formed in a front side of a middle of the brush head body, mounting grooves are formed in front sides of two ends of the brush head body, a back side of a top end of the sleeve rod is correspondingly mounted and integrally injection-molded in the connecting groove, brush blocks are injection-molded in the mounting grooves, brush sets are disposed on the front side of the top end of the sleeve rod and on the brush blocks, and an arc-shaped U-groove is formed in a back side of a corner of the brush head body.

2. The three-sided brush head for electric toothbrushes according to claim 1, wherein a plurality of sets of protrusions for removing tongue coatings are disposed on a back side of the brush head body.

3. The three-sided brush head for electric toothbrushes according to claim 1, further comprising a protective cover, wherein an insertion strip to be connected into the U-groove is disposed on an inner wall of the protective cover, a partition plate is vertically disposed in the protective cover, the insertion strip is correspondingly inserted into the U-groove, and the partition plate is inserted into a front side of the brush head body and clamps the brush head body together with the insertion strip.

4. The three-sided brush head for electric toothbrushes according to claim 1, wherein two end faces of the brush head body are arc.
